(19) United States
(12) Patent Application Publication
(10) Pub. No.: US 2016/0062551 A1
(43) Pub. Date: Mar. 3, 2016

(54) NON-TRANSITORY RECORDING MEDIUM STORING COMPUTER READABLE OBJECT DISPLAY CONTROL PROGRAM, OBJECT DISPLAY DEVICE, AND OBJECT DISPLAY SYSTEM

(71) Applicant: Konica Minolta, Inc., Tokyo (JP)

(72) Inventors: IKUKO TSUBOTANI, Tokyo (JP); SHINYA OGINO, Tokyo (JP); SHUNSUKE TAKAMURA, Tokyo (JP); KAZUMA TAKEUCHI, Tokyo (JP)

(21) Appl. No.: 14/832,856

(22) Filed: Aug. 21, 2015

(30) Foreign Application Priority Data
Sep. 2, 2014 (JP) 2014-177687

(51) Int. Cl. G06F 3/0481; G06F 3/0484

(52) U.S. Cl. CPC G06F 3/0481; G06F 3/04842

(57) ABSTRACT

A non-transitory recording medium storing a computer readable object display control program, the program being configured to run on a device, is provided, wherein the device includes: a display part which displays an object on a screen; and an operation part which enables manipulating the object, wherein the program causes the device to perform: a first process in which, when an object is selected from a plurality of objects forming one file, a group of objects contained in the file is specified, the group of objects being associated with the object having been selected; and a second process in which, when one or more of the objects having been selected are displayed on the display part, the group of objects associated with each of the objects having been selected is displayed so as to be viewed.

The entire disclosure of Japanese Patent Application No. 2014-177687 filed on Sep. 2, 2014 including description, claims, drawings, and abstract are incorporated herein by reference in its entirety.

### BACKGROUND OF THE INVENTION

1. Technological Field

The present invention relates to a non-transitory recording medium storing a computer readable object display control program. The invention also relates to an object display device configured to run the object display control program. The invention further relates to an object display system in which the object display devices are network-connected.

2. Background

When integrated material or the like is prepared, usually contents of several files are studied in parallel, and part of the contents of each file is extracted to formulate a conclusion. For example, extracted contents are gathered on a single working window to be combined, while the respective files are opened on separate windows. The windows are switched depending on the need to check contents thereof. Alternatively, reduced windows showing the respective files are arranged on the same screen so as to be viewed at one time.

However, in the case of switching windows to check contents of each of the files, a user has to come and go repeatedly between the working window and each of the file windows. This makes operations complicated. In the case of viewing reduced windows arranged in a single screen, a user has to enlarge the windows one by one to find a part to which the user wishes to refer. This also makes operations complicated. While frequently switching windows or enlarging windows, the user loses time for thinking which should originally be used for data integration.

### DESCRIPTION OF THE RELATED ART

JP 09-081475 A discloses an information terminal device as a technology related to file display as described above. The information terminal device includes a display unit and/or an entry and editing unit. The display unit is configured to display an information file containing at least one type of information among text information, graphic information, and image information. The entry and editing unit is configured to input and edit the information file. The information terminal device is provided with: a communication unit configured to send and receive the information file and control information; and a unit for linking the information terminal device and another information terminal device. At least one piece of the information file is displayed as split between the information terminal device and another information terminal device linked with the information terminal device.

When preparing integrated material, a user wishes to refer to only an object such as a text, a graphic, and an image, and a group of objects associated with the object (for example, objects appearing near the object). For preparing integrated material efficiently, therefore, it is important to display only a necessary object in each file.

However, in the aforementioned technology of JP 09-081475A, an information file is simply split to be displayed in multiple information terminal device. In order to display only a required object on a desired information terminal device, a user, on his/her own, has to select the required object residing in each file and also has to specify the desired information terminal device as a display location of the selected object. This, again, makes operations complicated. In addition, in the technology of JP 09-081475 A, a plurality of information terminal devices is needed. The technology, therefore, is not efficient in respect of securing space and management.

### SUMMARY

The present invention has been made in view of the foregoing, and a main object thereof is to provide a non-transitory recording medium storing a computer readable object display control program, an object display device, and an object display system which are capable of effectively displaying an object that should be referred to.

To achieve the abovementioned object, according to an aspect, a non-transitory recording medium storing a computer readable object display control program that runs on a device, reflecting one aspect of the present invention, is provided, wherein the device includes: a display part which displays an object on a screen; and an operation part which enables manipulating the object, and the program causes the device to perform: a first process in which, when an object is selected from a plurality of objects forming one file, a group of objects contained in the file is specified, the group of objects being associated with the object having been selected; and a second process in which, when one or more of the objects having been selected are displayed on the display part, the group of objects associated with each of the objects having been selected is displayed so as to be viewed.

To achieve the abovementioned object, according to an aspect, an object display device reflecting one aspect of the present invention comprises: a display part which displays an object on a screen; an operation part which enables manipulating the object; and a control part which controls the display part and the operation part, wherein, when an object is selected from a plurality of objects forming one file, the control part specifies a group of objects contained in the file, the group of objects being associated with the object having been selected, and, when one or more of the objects having been selected are displayed on the display part, the control part causes the group of objects associated with each of the objects having been selected to be displayed so as to be viewed.

To achieve the abovementioned object, according to an aspect, an object display system reflecting one aspect of the present invention comprises a plurality of object display devices, the object display device including: a display part which displays an object on a screen; an operation part which enables manipulating the object; and a control part which controls the display part and the operation part, and the object display devices being network-connected, wherein: the control part of a first object display device, when an object is selected from a plurality of objects forming one file, specifies a group of objects contained in the file, the group of objects being associated with the object having been selected, and sends data of the object having been selected and the group of objects to a second object display device; and the control part of the second object display device receives the data of the object having been selected and the group of objects, and, when one or more of the objects having been selected are displayed on the display part, causes the group of objects associated with each of the objects having been selected to be displayed so as to be viewed.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, and wherein:

FIGS. 1A to 1C are schematic diagrams each showing an object display device according to an embodiment of the present invention;

FIGS. 2A and 2B are block diagrams showing a configuration of an object display device according to an embodiment of the present invention;

FIG. 3 is a schematic diagram showing an object display system according to an embodiment of the present invention;

FIGS. 4A to 4C are diagrams showing a configuration of a screen displayed on an object display device according to an embodiment of the present invention;

FIGS. 5A to 5C are diagrams showing another configuration of a screen displayed on an object display device according to an embodiment of the present invention;

FIGS. 6A to 6C are diagrams showing another configuration of a screen displayed on an object display device according to an embodiment of the present invention;

FIG. 7 is a diagram showing another configuration of a screen displayed on an object display device according to an embodiment of the present invention;

FIG. 8 is a diagram showing another configuration of a screen displayed on an object display device according to an embodiment of the present invention;

FIG. 9 is a diagram showing another configuration of a screen displayed on an object display device according to an embodiment of the present invention;

FIG. 10 is a diagram showing an example of switching of screens displayed on an object display device according to an embodiment of the present invention;

FIG. 11 is a diagram showing another example of switching of screens displayed on an object display device according to an embodiment of the present invention;

FIG. 12 is a diagram showing another example of switching of screens displayed on an object display device according to an embodiment of the present invention;

FIG. 13 is a flow diagram showing a process performed by an object display device according to an embodiment of the present invention;

FIG. 14 is a flow diagram showing a process (a process for editing on a working window) performed by an object display device according to an embodiment of the present invention;

FIG. 15 is a flow diagram showing a process (a process for copying an object) performed by an object display device according to an embodiment of the present invention; and

FIG. 16 is a flow diagram showing a process (a process for specifying a group of objects) performed by an object display device according to an embodiment of the present invention.

### DESCRIPTION OF THE PREFERRED EMBODIMENTS

Hereinafter, an embodiment of the present invention will be described with reference to the drawings. However, the scope of the invention is not limited to the illustrated examples.

As discussed in Background, operations are complicated in preparing an integrated material by extracting desired objects from multiple files, because, in order to check contents of the files, the files need to be opened in separate windows and the windows need to be switched, or, the windows need to be reduced so that all the windows can be arranged and viewed on the same screen.

When preparing an integrated material, a user wishes to refer to an object extracted from each file and context of the extracted object. The context includes information about discussions from which a conclusion has been derived (i.e., a group of objects associated with the extracted object). It is desired, therefore, that a simple method for comparison and reference of the context be offered.

In view of the above, in an embodiment of the present invention, when a certain object is selected from a file or a piece of handwritten information containing a plurality of objects, part of the file or the piece of handwritten information (a group of objects forming part of the file or the piece of handwritten information) is specified, the part being associated with the object having been selected. When the object having been selected is displayed, the group of objects having been specified is displayed so as to be viewed, instead of the entirety of the file or the piece of handwritten information.

When the group of objects associated with the object having been selected is displayed so as to be viewed, as described above, operations of preparing integrated material are easily performed while more than one file or piece of handwritten information is viewed.

### EMBODIMENTS

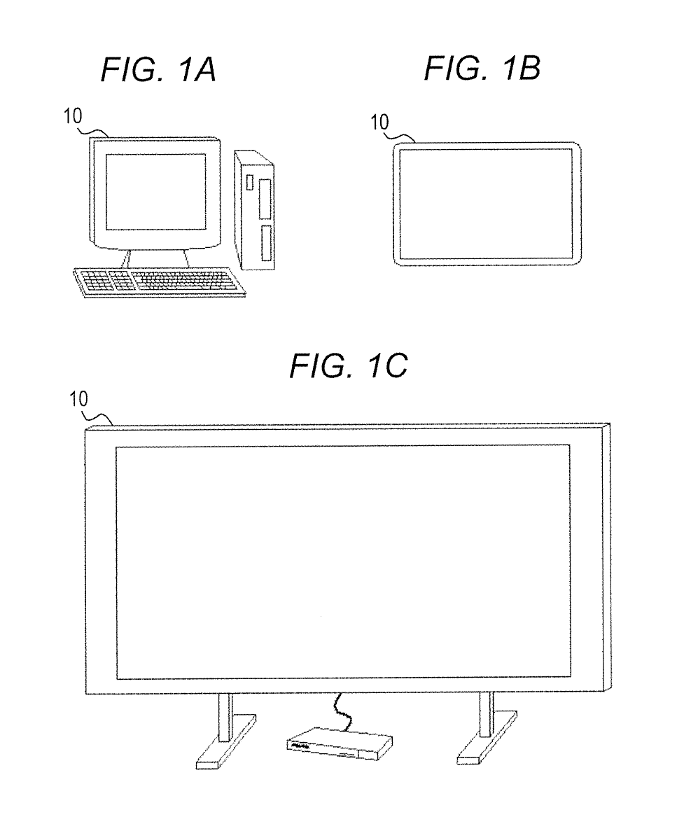

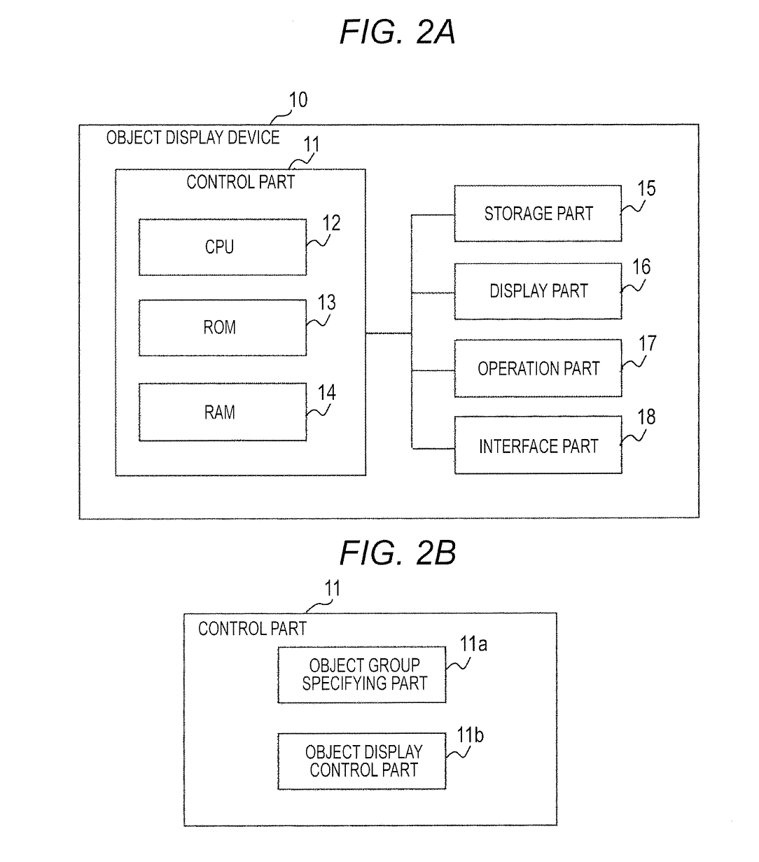

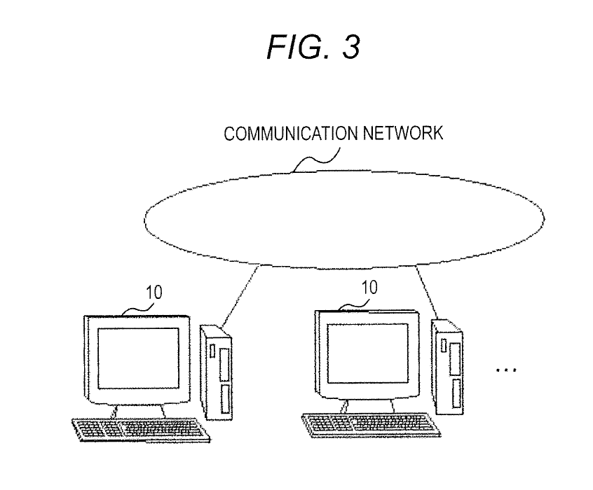

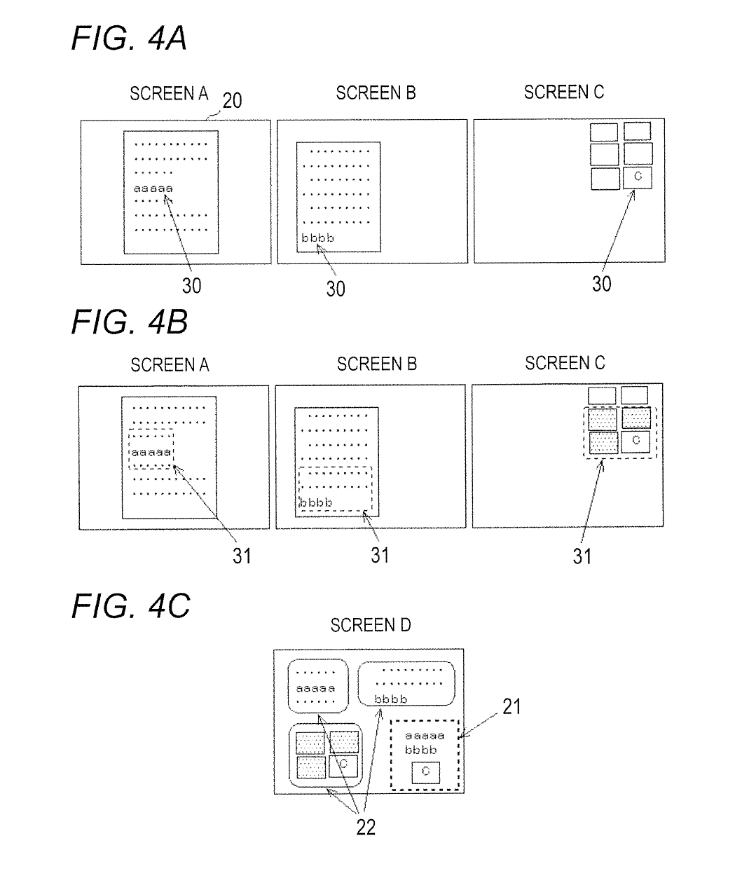

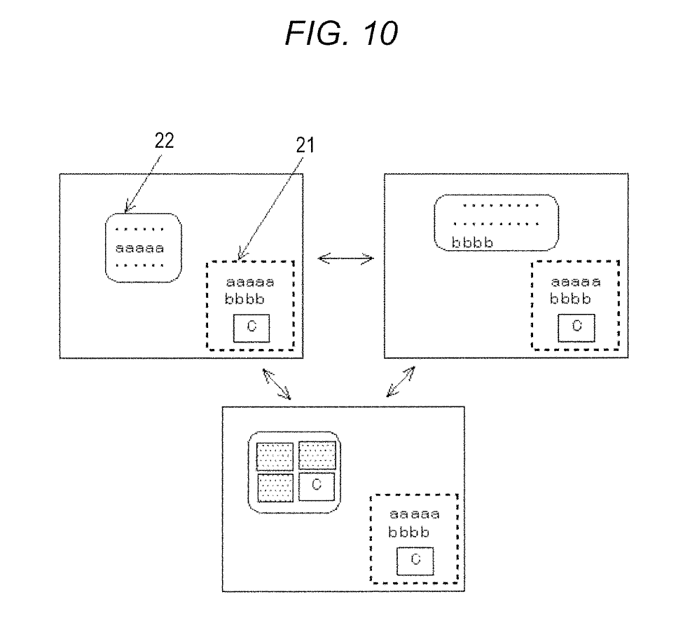

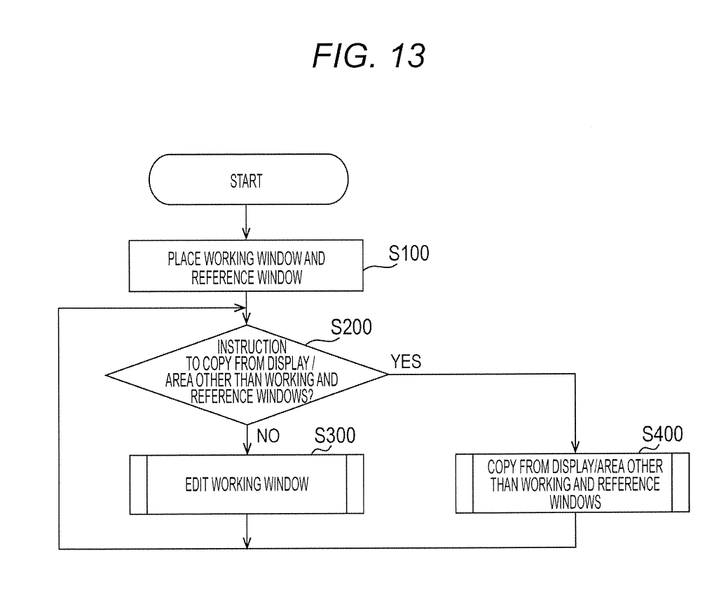

To give a more detailed description of an embodiment of the present invention, an object display control program, an object display device, and an object display system, according to an embodiment of the present invention, are described below with reference to FIGS. 1A to 16. FIGS. 1A to 1C are schematic diagrams each showing an object display device according to the present embodiment. FIGS. 2A and 2B are block diagrams showing a configuration of the object display device. FIG. 3 is a schematic diagram showing the object display system. FIGS. 4A to 9 are diagrams showing configuration examples of a screen displayed on the object display device. FIGS. 10 to 12 are diagrams showing examples of switching of the screens. FIGS. 13 to 16 are flow diagrams each showing a process of operation of an object display device according to the embodiment.

In the following description, an object means a specified unit of text information, graphic information, or image information. The specified unit of text information includes a single character, a word formed by combining characters, and a clause formed by combining words. The specified unit of graphic information includes a figure defined by a single line and a figure formed by combining lines. A file and a piece of handwritten information mean a manageable unit that the control part is able to control. The file and the piece of handwritten information include a plurality of objects.

The object display device 10 of the present embodiment is a device that is capable of manipulating and displaying an object. Examples of the object display device 10 include a computer device such as a personal computer shown in FIG. 1A, a tablet device shown in FIG. 1B, and an electronic blackboard shown in FIG. 1C. The object display device 10 can operate alone. Alternatively, as shown in FIG. 3, a plurality of object display devices 10 can be connected to each other via a communication network to form an object display system.

The object display device 10 has, as shown in FIG. 2A, a control part 11, a storage part 15, a display part 16, an operation part 17, an interface part 18, and others.

The control part 11 has a central processing unit (CPU) 12, and a memory such as a read only memory (ROM) 13 and a random access memory (RAM) 14. The CPU 12 controls operations of the entire object display device 10 by calling a control program from the ROM 13 and the storage part 15, and loading the program into the RAM 14 to execute the program. The control part 11 also runs various applications on an operating system (OS), enabling creation and editing of a file and a piece of handwritten information which contain a plurality of objects.

The storage part 15 includes a flash memory, a hard disk drive (HDD), a solid state drive (SSD), and the like. The storage part 15 stores data of the OS and the applications mentioned above, and data of a file and a piece of handwritten information. The storage part 15 stores, as needed, a database describing relationship between objects.

The display part 16 displays an object on a screen depending on the control of the control part 11. Examples of the display part 16 include a liquid crystal display (LCD), and an electro luminescence (EL) display.

The operation part 17 receives various operations (e.g., operations for running an application, for selecting objects, and for switching screens). Examples of the operation part 17 include a mouse, a keyboard, a touch sensor formed of grid electrodes placed on the display part 16, and a hardware key.

The interface part 18 is provided as needed to establish communication with another object display device 10 connected to a communication network, and a server having a database server described later. Examples of the interface part 18 include a network interface card (NIC), and a modem.

As shown in FIG. 2B, the control part 11 also functions as an object group specifying part 11a and an object display control part 11b.

The object group specifying part 11a specifies, when an object is selected from a file or apiece of handwritten information which contain a plurality of objects, one or more objects associated with the object having been selected. (The object having been selected is hereinafter called a selected object. The objects associated with the selected object is hereinafter called a relevant object group.)

Specifically, when an object is selected from objects appearing on the display part 16, objects appearing in a predetermined distance range with reference to the display position of the selected object (for example, within a 10-cm radius) are specified as a relevant object group. When objects are grouped in advance, objects belonging to the same group as the selected object are specified as a relevant object group. When objects include portions aligned according to a predetermined order (e.g., items and paragraphs), and, in addition, when the selected object is part of such portion (e.g., a sentence in an item and part of a paragraph), the entire portion is specified as a relevant object group. When the selected object and other objects are arranged in a structure described by a line or an arrow, and are controlled in a hierarchy, objects belonging to a specified hierarchy level that includes the selected object are specified as a relevant object group. When the selected object and another object (a second object) overlap each other (e.g., a table, and a four-quadrant diagram), the selected object and the second object are specified as a relevant object group. Alternatively, when the second object and another object (a third object) overlap each other, the selected object and the second object together with the third object are specified as a relevant object group. When an object is selected from a piece of handwritten information, objects created within a specified time range with reference to the selected object (for example, within 10 minutes before or after the creation of the selected object), or objects created within a specified range of chronological order with reference to the selected object are specified as a relevant object group. When relationships among a plurality of objects are described in a database, objects described in the database as objects associated with the selected object are specified as a relevant object group.

At the time of selecting an object, the above-mentioned file or the piece of handwritten information themselves are not necessarily displayed on the display part 16. For example, in the case of objects included in a piece of handwritten information, which are stored as pieces of image data in the storage part 15, when a certain piece of image data is selected from a list of the pieces of image data, pieces of image data created within a specified range of time or chronological order with reference to the selected image data are specified as a relevant object group.

The object display control part 11b, when the selected object is displayed on the display part 16, causes the relevant object group specified by the object group specifying part 11a to be displayed so as to be viewed. For example, the selected object and the relevant object group are displayed on the same screen, or on separate switchable screens. In this case, to distinguish between the selected object and the relevant object group, the selected object is displayed on the working window in a distinguishable manner, while the relevant object group is displayed on a reference window, as necessary. Operations of the object display control part 11b will be described in detail later.

The object group specifying part 11a and the object display control part 11b can be configured as hardware. Alternatively, the control part 11 can be configured as software which functions as the object group specifying part 11a and the object display control part 11b (i.e., an object display control program). The object display control program is run by the CPU 12.

In the case of the object display system shown in FIG. 3, in one or more object display devices 10, the control part 11 can function as the object group specifying part 11a, which sends data of the selected object and the relevant object group to another object display device 10. In the object display device 10 which receives data of the selected object and the relevant object group, the control part 11 can function as an object display control part 11b, so that the selected object and the relevant object group can be displayed on the display part 16 of the object display device 10. In this case, integrated material is prepared by using the object display device 10 which receives the data.

The following is a description of operations of the object display device 10 having a configuration described above. FIGS. 4A to 4C show an example of a configuration of screens displayed on the display part 16.

First, as shown in the left drawing of FIG. 4A, a file created by an application is displayed on the screen 20 (a screen A). In this state, the operation part 17 is operated to select an object that forms part of the file (letters “aaaaa” in the drawing). Then, data of the selected object 30 is stored in the storage part 15. How to select an object is at the user's option. For example, the user selects the object by clicking a mouse on the object or by specifying a rectangular area including the object with a mouse. When the operation part 17 is a touch panel, the user selects an object by touching or long-pressing the object.

When an object is selected, the object group specifying part 11a specifies a relevant object group 31 associated with the selected object 30, as shown in the left drawing of FIG. 4B. The object group specifying part 11a then connects the data of the relevant object group 31 to that of the selected object 30. Information about the connected data is stored in the storage part 15. In the example, a portion in which objects are aligned according to a predetermined order (an itemized portion) is specified as a relevant object group 31. Also in the example, the relevant object group 31 is surrounded by a broken line so as to be visible. Other than this, the relevant object group 31 can be displayed in an arbitrary form such as a different color, blinking, and a different line width (e.g., boldface). When it is not necessary to confirm which objects have been specified as a relevant object group 31, the display form of the relevant object group 31 does not need to be changed.

When an object is selected from another file (a second file), after an object has been selected and a relevant object group has been specified on the screen A, the second file is displayed, as shown in the middle drawing of FIG. 4A, by closing the currently displayed file (or by switching screens). Subsequently, with the second file is displayed on the screen 20 (a screen B), the operation part 17 is operated to select an object that forms part of the file (letters “bbbb” in the drawing). Then, data of the selected object 30 is stored in the storage part 15. When the object is selected, the object group specifying part 11a specifies the relevant object group 31 (a portion surrounded by a broken line) associated with the selected object 30, as shown in the left drawing of FIG. 4B. Then the object group specifying part 11a connects the data of the relevant object group 31 to that of the selected object 30. Information about the connected data is stored in the storage part 15. In the example, a portion in which objects are aligned according to a predetermined order (a paragraphed portion) is specified as a relevant object group 31.

When an object is selected from a piece of handwritten information, after an object has been selected and a relevant object group has been specified on the screen B, the currently displayed file is closed (or screens are switched), so that the piece of handwritten information is created/displayed as shown in the right drawing of FIG. 4A. Subsequently, with the piece of handwritten information displayed on the screen 20 (a screen C), the operation part 17 is operated to select an object that forms part of the piece of handwritten information (an object “c” in the drawing). Then, data of the selected object 30 is stored in the storage part 15. When the object is selected, the object group specifying part 11a specifies, as shown in the right drawing of FIG. 4B, the relevant object group 31 (an object hatched with dotted lines) associated with the selected object 30. Then the object group specifying part 11a connects the data of the relevant object group 31 to that of the selected object 30. Information about the connected data is stored in the storage part 15. In the example, the following cases are shown, in which: objects are grouped in advance, and objects belonging to the same group as the selected object 30 are specified as a relevant object group 31; alternatively, objects are controlled in a hierarchy, and objects belonging to a specified hierarchy level that includes the selected object 30 are specified as a relevant object group 31; and, alternatively, handwritten objects created within, with reference to the selected object 30, a specified distance range, a specified time range, or a specified range of chronological order, are specified as a relevant object group 31.

Subsequently, when an instruction to copy the selected object 30 is received through the operation part 17 (for example, by pressing a button on the screen or a hardware key, or by selecting a copy command from a menu screen), the object display control part 11b reads the data of the selected object 30 and the relevant object group 31 from the storage part 15. The object display control part 11b then displays, as shown in FIG. 4C, the selected objects 30 together in one place on the screen 20. At the same time, the object display control part 11b displays the relevant object groups 31 near the selected objects 30 in a viewable manner. For example, the selected object 30 is displayed in the working window 21 placed in advance, while the relevant object group 31 is displayed in the reference window 22 placed in the surrounding area of the working window 21. At this time, a selected object 30 appearing in a relevant object group 31 can be changed in display form (for example, highlighted in a different color, or in a bold typeface).

As described above, when an object is selected from a plurality of files or pieces of handwritten information, a relevant object group 31 associated with the selected object 30 is specified. Then the selected object 30 and the relevant object group 31 are displayed together on the screen 20. This makes it easy to prepare integrated material while referring to or comparing the contents of the files and the pieces of handwritten information.

In FIGS. 4A to 4C, an object is selected from each of the two files and one piece of handwritten information which appear separately in three screens. However, the amount and number of files and pieces of handwritten information from which an object is selected, and the amount and number of objects selected from each file or each piece of handwritten information are arbitrarily determined. In the case of FIGS. 4A to 4C, a relevant object group 31 is specified each time an object is selected. However, operations can be controlled in such a manner that all relevant object groups 31 are specified simultaneously after selection of objects has finished.

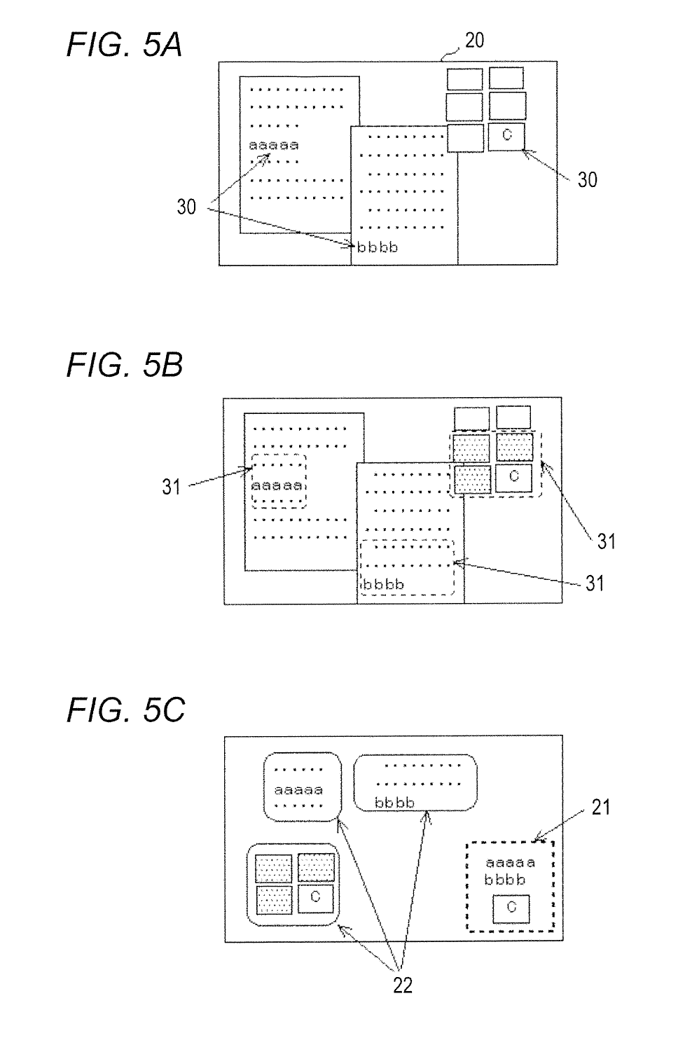

The object display device 10 having the display part 16 with a large screen as shown in FIG. 1C is controlled similarly to the above. For example, in FIG. 5A, a plurality of files and pieces of handwritten information are displayed on the screen 20. In this case, when an object is selected from each of the files and pieces of handwritten information, the object group specifying part 11a specifies, as shown in FIG. 5B, a relevant object group 31 associated with the selected object 30. The object display control part 11b then displays, as shown in FIG. 5C, the selected objects 30 together in one place on the screen 20. At the same time, the object display control part 11b displays the relevant object groups 31 near the selected objects 30 in a viewable manner. As has been described, only a selected object 30 selected from a file or a piece of handwritten information, and a relevant object group 31 associated with the selected object 30 are displayed, instead of displaying the file and the piece of handwritten information in their entirety. This facilitates preparation of integrated material.

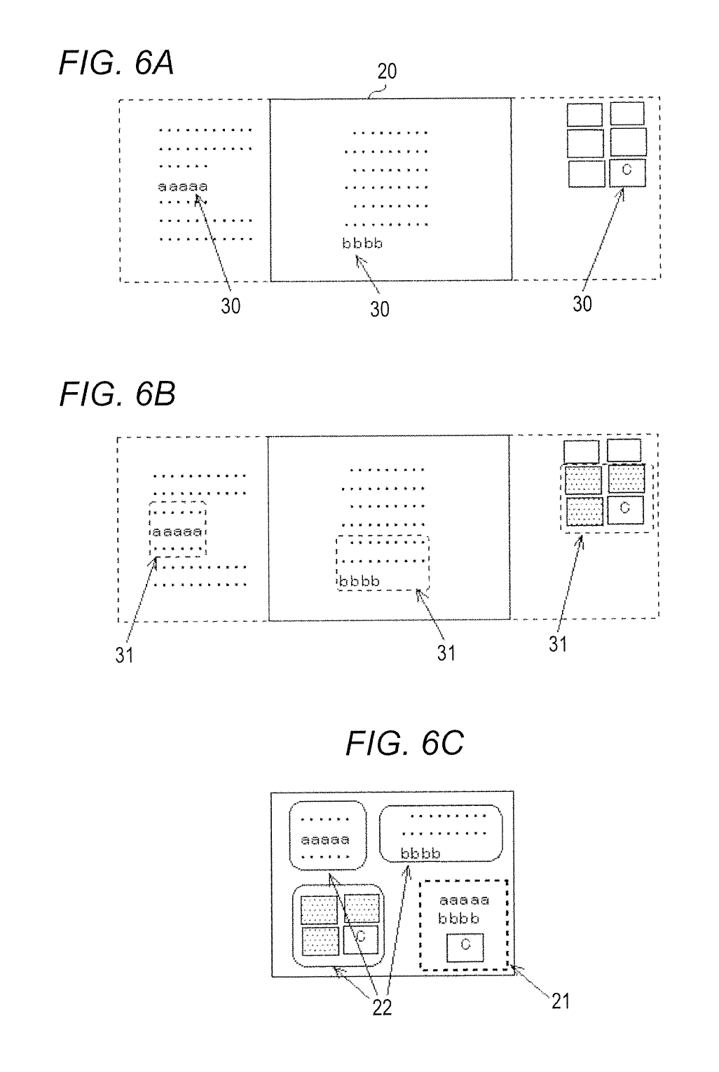

In FIGS. 4A to 5C, a file or a piece of handwritten information is displayed in a window fitting in the screen 20. Other than this, the file and the piece of handwritten information can be viewed, for example, while being moved on the screen 20. In this case, too, the object display device 10 is controlled similarly to the case of FIGS. 4A to 5C. For example, in FIG. 6A, part of a file or a piece of handwritten information is displayed on the screen 20. Each time an object is selected from the displayed part, the object group specifying part 11a specifies, as shown in FIG. 6B, a relevant object group 31 associated with the selected object 30. The object display control part 11b then displays, as shown in FIG. 6C, the selected objects 30 together in one place on the screen 20. At the same time, the object display control part 11b displays the relevant object groups 31 near the selected objects 30 in a viewable manner. As described above, even in the case of viewing the file or the piece of handwritten information of which the display size is larger than the screen 20, the selected object 30 and the relevant object group 31 are displayed together on the screen 20. This facilitates preparation of integrated material.

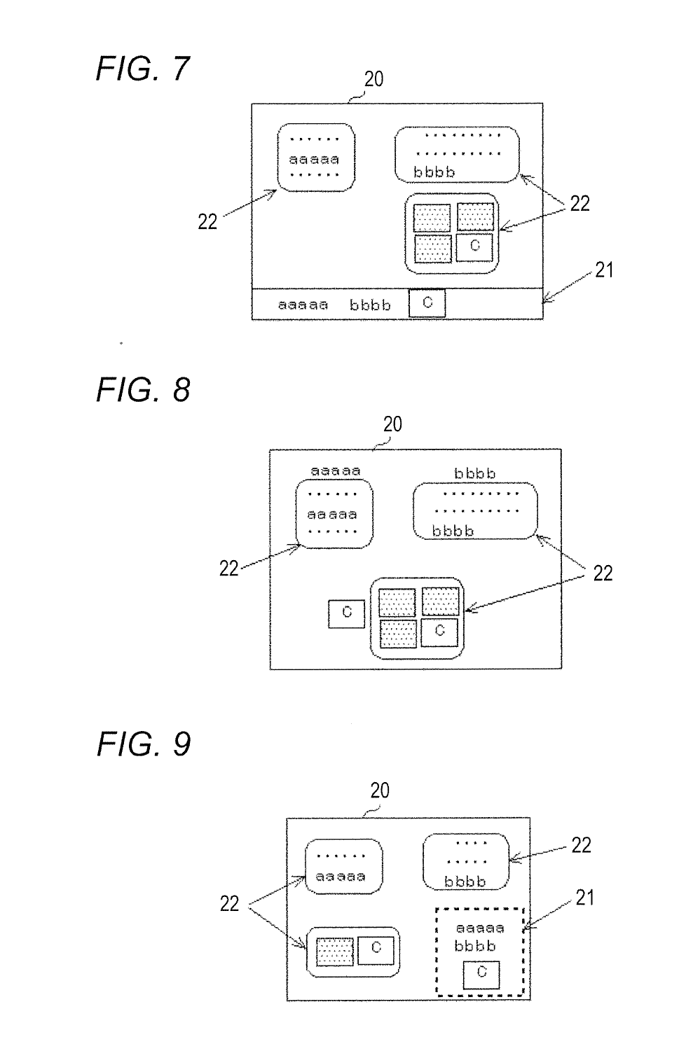

In the cases of FIGS. 4A to 6C, a rectangular working window 21 is displayed on the screen 20. However, the form of the working window 21 can be arbitrarily chosen. It is optional whether or not to display a border and the like outlining the working window 21 so that the working window 21 can be distinguished from the other windows. The working window 21 is placed at an arbitrary position. For example, as shown in FIG. 7, a certain area in the screen 20 (a bottom section in FIG. 7) is specified as the working window 21. The selected objects 30 are displayed in a row in the specified area. In the cases of FIGS. 4A to 7, the working window 21 is displayed on the screen 20, so that the selected objects 30 are displayed together in the working window 21. Other than this, as shown in FIG. 8, for example, the selected objects 30 can be displayed separately, without displaying the working window 21. At this time, the relevant object group 31 corresponding to each of the selected objects 30 can be displayed close to the respective selected objects 30.

In the cases of FIGS. 4A to 8, the relevant object group 31 having been specified is displayed in its entirety on the screen 20. When the display size of the relevant object group 31 is large, however, it may be difficult to display the entirety of the relevant object group 31 on the screen 20. Besides, visibility of the relevant object group 31 may decrease, when the entirety of the relevant object group 31 is displayed on the screen 20. In such case, part of the relevant object group 31 is displayed in the reference window 22, as shown in FIG. 9. Then, for example, the relevant object group 31 is scrolled in the reference window 22, or the reference window 22 is enlarged so that the entirety of the relevant object group 31 can be viewed. Alternatively, the relevant object group 31 is shrunk to be displayed in the reference window 22, but is magnified depending on operations in the reference window 22. Another option is to display, in the reference window 22, the storage destination (a link) of the data of the relevant object group 31. When the storage destination is clicked on, the relevant object group 31 appears.

In display configurations shown in FIGS. 4A to 9, the selected object 30 is included in the relevant object group 31. However, objects excluding the selected object 30 can be displayed as the relevant object group 31.

In the cases of FIGS. 4A to 9, the selected object 30 and the relevant object group 31 are displayed together on the single screen 20. However, when the size of the relevant object group 31 is large, or when there are a large number of the relevant object groups 31, it may be difficult to display all the relevant object groups 31 on the screen 20 at one time. In such case, as shown in FIG. 10, for example, the relevant object groups 31 are displayed individually, while the selected objects 30 are displayed all together. The relevant object groups 31 are displayed one by one as the screens are switched.

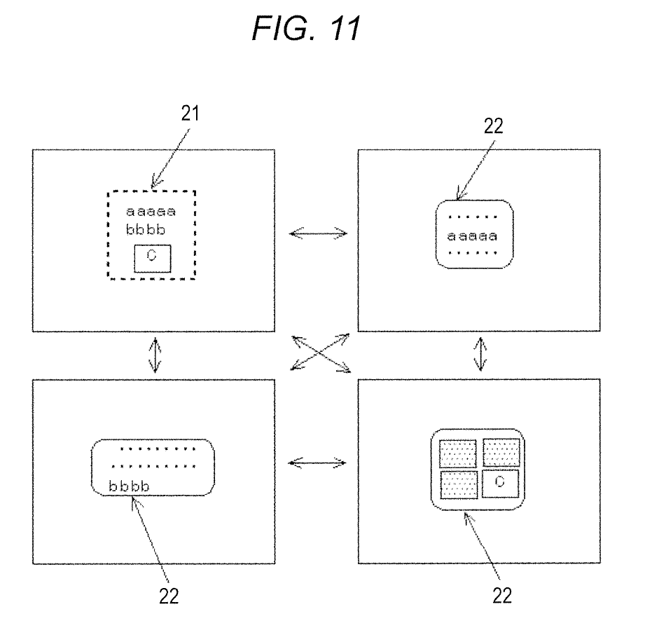

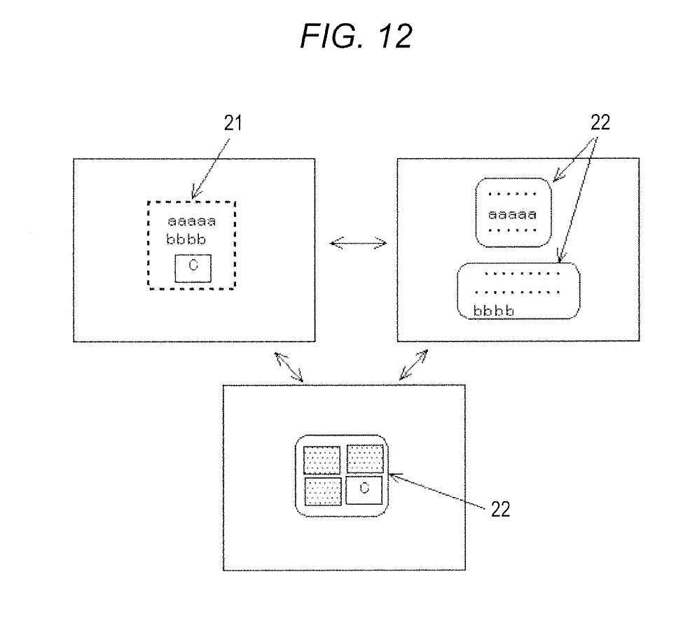

In the cases of FIGS. 4A to 10, the selected object 30 and the relevant object group 31 are displayed simultaneously on the single screen 20. However, the selected object 30 and the relevant object group 31 can be displayed on separate screens. For example, as shown in FIG. 11, while the selected objects 30 are displayed together on one screen, the relevant object groups 31 are displayed on other screens individually. The screens are freely switchable. In addition, as shown in FIG. 12, while the selected objects 30 are displayed together on one screen, the relevant object groups 31 can be displayed on other screens in groups (objects of the same type are specified as a group). The screens are freely switchable.

In the cases shown in FIGS. 4A to 12, an object is selected from a file or apiece of handwritten information. In some cases, however, it is difficult to select an object, depending on the form of the file or a piece of handwritten information. For example, when a paragraph in a document specified by the file is selected in its entirety, a plurality of objects (characters) forming the paragraph has to be selected. Likewise, when a figure formed of a plurality of lines (objects) is selected in its entirety, the plurality of lines has to be selected. In such cases, a region (such as a region including “aaaaa” or “bbbb”, or a region including the object “c”, which is hereinafter called a minimum region) is selected, instead of selecting the objects directly. The object group specifying part 11a specifies a region extending from the minimum region (hereinafter called a surrounding region) as a relevant object group 31. The object display control part 11b, then, displays the minimum regions together in the working window 21, and the surrounding regions in the reference window. Since a region is specified as described above, operations for selecting objects are simplified for the user. This, as a result, facilitates preparation of integrated material.

In the cases shown in FIGS. 4A to 12, description has been given of displaying the selected object 30 and the relevant object group 31. In some cases, however, the original file or piece of handwritten information is displayed again, after integrated material is prepared while the selected object 30 and the relevant object group 31 are revised. In such case, by saving the selected object 30 and the relevant object group 31 as new pieces of data to be stored separately from the original file or piece of handwritten information, the original file or piece of handwritten information is not affected by a change in the state (e.g., addition or erasure of information) of the selected object 30 and the relevant object group 31.

The following is a description of operations of the control part 11 included in the object display device 10. The CPU 12 loads the object display control program having been stored in the ROM 13 or the storage part 15 into the RAM 14, and runs the program so as to perform each step of operations shown in the flow diagrams of FIGS. 13 to 16.

First, as shown in FIG. 13, the control part 11 places, on the screen 20, a working window and a reference window, in which the selected object 30 and the relevant object group 31 are displayed, respectively (step S100). Next, the control part 11 monitors operations of the operation part 17. The control part 11 determines whether or not an instruction received through the operation part 17 is a command to copy from a screen other than the screen on which the working window and the reference window are placed, or to copy from an area other than the working window and the reference window (step S200).

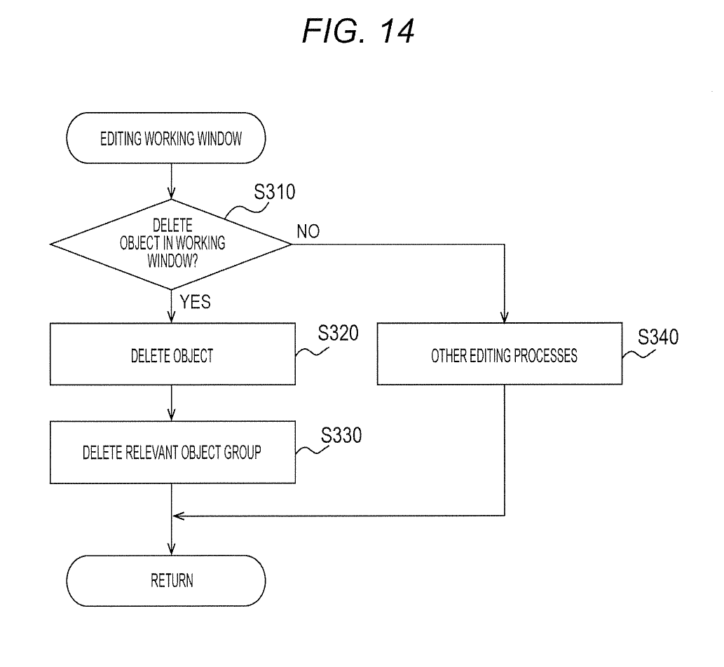

When it is determined that the instruction received through the operation part 17 is not a command to copy from the above-mentioned area or the screen other than the screen on which the working window and the reference window are placed, the control part 11 performs a process for editing the working window (step S300). FIG. 14 shows details of the process for editing the working window. First, the control part 11 determines whether or not an instruction received through the operation part 17 is a command to delete an object in the working window (the selected object 30) (step S310). When it is determined that the instruction is a command to delete the selected object 30, the control part 11 deletes the selected object 30 in the working window (deletion of the displayed object and, as necessary, erasure of data) (step S320). At the same time, the control part 11 deletes the relevant object group 31 associated with the selected object 30 (deletion of the displayed object and, as necessary, erasure of data) (step S330). When it is determined that the instruction is not a command to delete the selected object 30, the control part 11 performs a process for editing other than deleting the selected object 30 (for example, changing display position, size, and display form of the working window) (step S340).

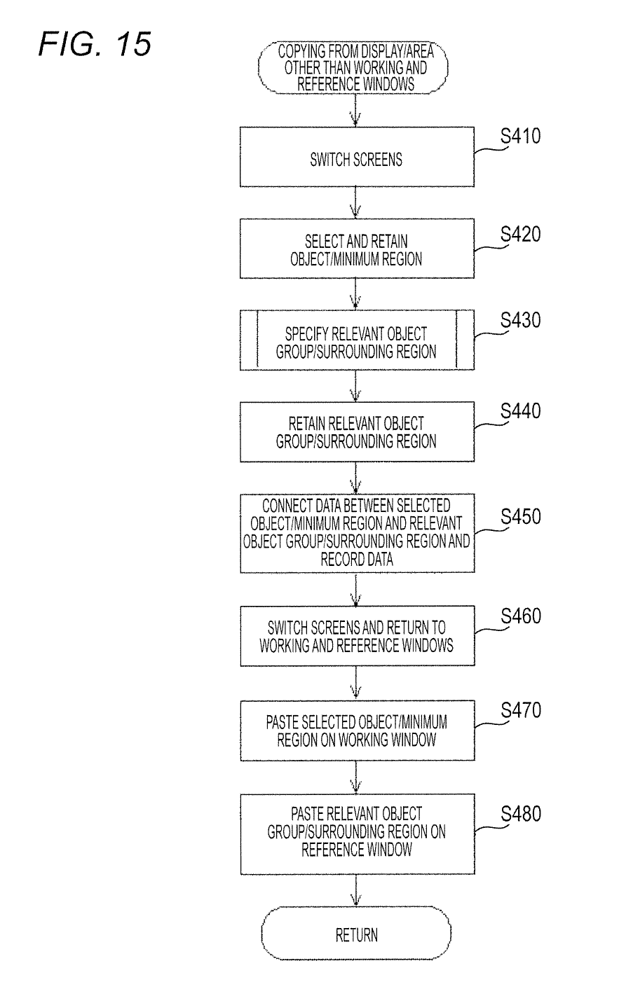

Back to FIG. 13, when it is determined that an instruction received through the operation part 17 is a command to copy from a screen other than the screen on which the working window and the reference window are placed, or to copy from an area other than the working window and the reference window, the control part 11 performs a process for copying as instructed (step S400). FIG. 15 shows details of the copy process. First, the control part 11 (the object display control part 11b) switches from the screen on which the working window and the reference window are placed to the screen on which a file or a piece of handwritten information are displayed (step S410).

When an object or a minimum region is selected, through the operation part 17, from the file or the piece of handwritten information, the control part 11 retains the data of the object or the minimum region having been selected in the RAM 14 or the like (step S420).

Next, the control part 11 (the object group specifying part 11a) specifies a relevant object group 31 associated with the object having been selected (or a surrounding region around the minimum region having been selected) (step S430). The process for specifying the relevant object group or the surrounding region is described in detail later. Subsequently, the control part 11 (the object group specifying part 11a) retains the data of the relevant object group 31 (or the surrounding region) in the RAM 14 or the like (step S440). The control part 11 then connects the data of the relevant object group 31 (or the surrounding region) retained in step S440 to the data of the selected object 30 (or the minimum region) retained in step S420. Information about the connected data is stored in the storage part 15 or the like (step S450).

Next, the control part 11 monitors operations of the operation part 17. When an instruction to copy the selected object (or objects of the minimum region) is received, the control part 11 switches from the screen on which the file or the piece of handwritten information is displayed to the screen on which the working window and the reference window are placed (step S460). The control part 11 (the object display control part 11b), then, pastes the selected object (or objects of the minimum region) on the working window (step S470). At the same time, the control part 11 (the object display control part 11b) pastes the relevant object group (or objects of the surrounding region) on the reference window (step S480), which completes the sequence of the copy process.

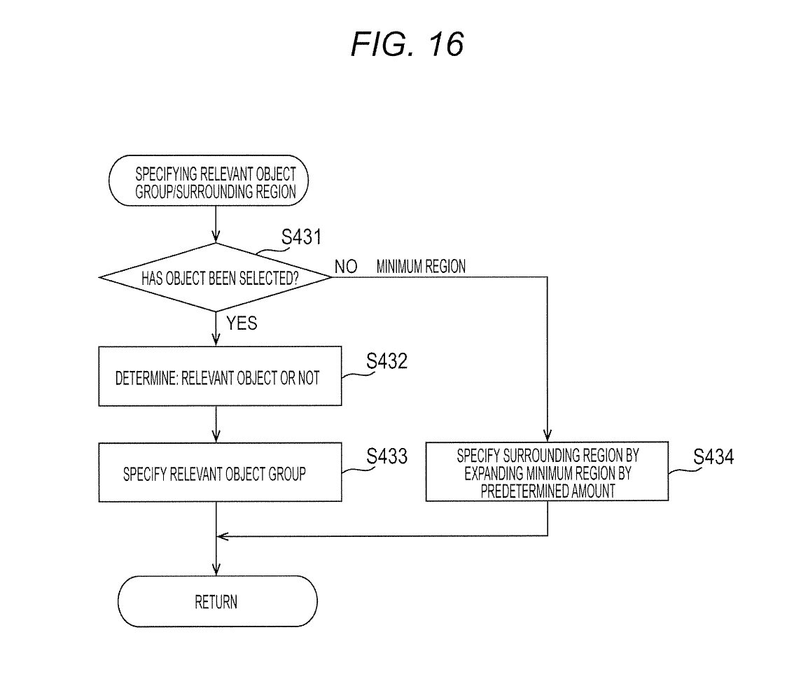

The following is a description of the process for specifying the relevant object group (or the surrounding region) shown in step S430. FIG. 16 shows details of the process. The control part 11 (the object group specifying part 11a) determines whether an object is selected or a minimum region is selected (step S431). When an object is selected, the control part 11 (the object group specifying part 11a) determines whether or not each of the other objects relates to the selected object (step S432). The control part 11 (the object group specifying part 11a) selects one or more objects which have been determined to be associated with the selected object, as a relevant object group 31 (step S433).

Specifically, as described previously, when objects are grouped in advance, one or more objects belonging to the same group as the selected object 30 are specified as the relevant object group 31. When objects include portions aligned according to a predetermined order, and also when the selected object 30 is part of such portion, the entire portion is specified as a relevant object group 31. When objects are controlled in a hierarchy, objects belonging to a specified hierarchy level that includes the selected object 30 are specified as a relevant object group 31. When the selected object 30 and another object (a second object) overlap each other, the selected object 30 and the second object are specified as a relevant object group 31. When the second object and another object (a third object) overlap each other, the selected object 30 and the second object together with the third object are specified as a relevant object group 31. Alternatively, objects created within, with reference to the selected object 30, a specified distance range, a specified time range, or a specified range of chronological order, are specified as a relevant object group 31. Alternatively, objects described in a database as objects associated with the selected object 30 are specified as a relevant object group 31. If there is no object which meets the above conditions, it is determined that there is no object associated with the selected object. No object is thus displayed as the relevant object group 31 with respect to the selected object 30.

Meanwhile, when a minimum region is selected in step S431, the control part 11 (the object group specifying part 11a) specifies a surrounding region. The surrounding region is specified by expanding the minimum region by a predetermined amount (step S434).

By the controls described in the foregoing, it becomes easier to prepare integrated material while referring to a plurality of files. In addition, the selected object and the original file or piece of handwritten information are linked together when recorded. It is easy, therefore, to retrieve a piece of reference data even if the original files and pieces of handwritten information are large in number.

The present invention is not limited to the above-described embodiment. The invention encompasses any alterations and modifications which fall within the scope of accomplishment of the object(s) thereof.

For example, in the foregoing embodiment, an object or a minimum region is selected from a file or a piece of handwritten information displayed on the display part 16. In some cases, items of data on files or pieces of handwritten information are stored in a hierarchical structure, and a list of the items of data is displayed on the display part 16. In such case, a piece of data is selected from the list. The control operations described in the above embodiment are also applicable to this case.

A relevant object group associated with a selected object, or a surrounding region including a minimum region is not necessarily the entirety of a file or apiece of handwritten information, but may be part of the file or the piece of handwritten information.

The present invention is applicable to an object display device and an object display system which are capable of displaying and manipulating an object, and a storage medium storing an object display control program which runs on the object display device.

Although embodiments of the present invention has been described and illustrated in detail, it is clearly understood that the same is by way of illustrated and example only and is not to be taken by way of limitation, the scope of the present invention being interpreted by terms of the appended claims.

What is claimed is:

1. A non-transitory recording medium storing a computer readable object display control program, the program being configured to run on a device,
the device comprising:
a display part which displays an object on a screen; and
an operation part which enables manipulating the object, wherein
the program causes the device to perform:
a first process in which, when an object is selected from a plurality of objects forming one file, a group of objects contained in the file is specified, the group of objects being associated with the object having been selected; and
a second process in which, when one or more of the objects having been selected are displayed on the display part, the group of objects associated with each of the objects having been selected is displayed so as to be viewed.

2. The non-transitory recording medium storing a computer readable object display control program, according to claim 1, wherein,
in the first process, when the objects forming the file are displayed on the display part, objects to be specified as the object group are displayed within a predetermined distance range with reference to the display position of the object having been selected.

3. The non-transitory recording medium storing a computer readable object display control program, according to claim 1, wherein,
in the first process, when the objects forming the file are grouped in advance, objects to be specified as the object group belong to the same group as the object having been selected.

4. The non-transitory recording medium storing a computer readable object display control program, according to claim 1, wherein,
in the first process, when the objects forming the file contain portions aligned according to a predetermined order, and, at the same time, the object having been selected is part of one of the portions, the entirety of the portion is specified as the object group.

5. The non-transitory recording medium storing a computer readable object display control program, according to claim 1, wherein,
in the first process, when the objects forming the file are controlled in a hierarchy, objects to be specified as the object group belong to a specified hierarchy level that includes the object having been selected.

6. The non-transitory recording medium storing a computer readable object display control program, according to claim 1, wherein,
in the first process, objects to be specified as the object group are: when the object having been selected and another or a second object included in the objects forming the file overlap each other, the object having been selected and the second object; or, alternatively, when the second object and still another or a third object overlap each other, the object having been selected and the second object together with the third object.

7. The non-transitory recording medium storing a computer readable object display control program, according to claim 1, wherein
the device further comprises a storage part which stores a database describing relationship between objects, and
in the first process, the object group is specified by referring to the database.

8. The non-transitory recording medium storing a computer readable object display control program, according to claim 1, wherein,
in the second process, a plurality of the objects having been selected is displayed together in a predetermined area, and
the object groups are displayed in the vicinity of the area.

9. The non-transitory recording medium storing a computer readable object display control program, according to claim 8, wherein,
in the second process, the area is displayed in a distinguishable manner.

10. The non-transitory recording medium storing a computer readable object display control program, according to claim 1, wherein,
in the second process, the object group associated with the object having been selected is displayed in the vicinity of the display position of the respective objects having been selected.

11. The non-transitory recording medium storing a computer readable object display control program, according to claim 1, wherein,
in the second process, the object having been selected and the object group are displayed on separate switchable screens.

12. The non-transitory recording medium storing a computer readable object display control program, according to claim 8, wherein,
in the second process, part of each of the object groups or information by which each of the object groups is identified are displayed, and
the entirety of the object group is displayed depending on operations of the operation part.

13. An object display device comprising:
a display part which displays an object on a screen;
an operation part which enables manipulating the object; and
a control part which controls the display part and the operation part, wherein,
when an object is selected from a plurality of objects forming one file, the control part specifies a group of objects contained in the file, the group of objects being associated with the object having been selected, and,
when one or more of the objects having been selected are displayed on the display part, the control part causes the group of objects associated with each of the objects having been selected to be displayed so as to be viewed.

14. The object display device according to claim 13, wherein,
when the objects forming the file are displayed on the display part, the control part specifies, as the object group, objects displayed within a predetermined distance range with reference to the display position of the object having been selected.

15. The object display device according to claim 13, wherein, when the objects forming the file are grouped in advance, the control part specifies, as the object group, objects belonging to the same group as the object having been selected.

16. The object display device according to claim 13, wherein,
when the objects forming the file contain portions aligned according to a predetermined order, and, at the same time, the object having been selected is part of one of the portions, the control part specifies, as the object group, the entirety of the portion.

17. The object display device according to claim 13, wherein,
when the objects forming the file are controlled in a hierarchy, the control part specifies, as the object group, objects belonging to a specified hierarchy level that includes the object having been selected.

18. The object display device according to claim 13, wherein,
the control part specifies, as the object group:
when the object having been selected and another or a second object included in the objects forming the file overlap each other, the object having been selected and the second object; or, alternatively,
when the second object and still another or a third object overlap each other, the object having been selected and the second object together with the third object.

19. An object display system comprising a plurality of object display devices, the object display device including:
a display part which displays an object on a screen;
an operation part which enables manipulating the object; and
a control part which controls the display part and the operation part, and the object display devices being network-connected,
wherein:
the control part of a first object display device, when an object is selected from a plurality of objects forming one file, specifies a group of objects contained in the file, the group of objects being associated with the object having been selected, and sends data of the object having been selected and the group of objects to a second object display device; and
the control part of the second object display device receives the data of the object having been selected and the group of objects, and, when one or more of the objects having been selected are displayed on the display part, causes the group of objects associated with each of the objects having been selected to be displayed so as to be viewed.

20. The object display system according to claim 19, wherein
a server which retains a database describing relationship between objects is connected to a network, and
the control part of the first object display device specifies the object group by referring to the database.
